(19) United States
(12) Patent Application Publication
(10) Pub. No.: US 2007/0057876 A1
(43) Pub. Date: Mar. 15, 2007

(54) Display device and method of driving the same

(75) Inventor: Byoung Ik Kwon, Seongnam-city (KR)

Correspondence Address: FLESHNER & KIM, LLP, P.O. BOX 221200, CHANTILLY, VA, 20153, US

(73) Assignee: LG Electronics Inc.

(21) Appl. No.: 11/436,030

(22) Filed: May 18, 2006

(30) Foreign Application Priority Data
Sep. 13, 2005 (KR) 10-2005-0085238

(51) Int. Cl. G09G 3/30

(52) U.S. Cl. 345/76

(57) ABSTRACT

The present invention relates to a display device where an after-image is not displayed on a panel. The display device includes a panel and a driver. The panel displays at least one indicator. The driver drives the panel. Here, the indicator is changed by a predetermined way. The display device changes with a predetermined pattern an indicator, and thus an after-image is not occurred on a panel.

### BACKGROUND OF THE INVENTION

1. Field of the Invention

The present invention relates to a display device and a method of driving the same. More particularly, the present invention relates to a display device where an after-image is not displayed on a panel and a method of driving the same.

2. Description of the Related Art

A display device displays a certain image. Particularly, an organic electroluminescent device as the display device is self light-emitting device, and includes a plurality of sub-pixels formed in cross areas of anode electrode layers and cathode electrode layers. Here, each of the sub-pixels has an anode electrode layer, an organic layer and a cathode electrode layer formed in sequence on a substrate. When a positive voltage is applied to the anode electrode layer and a negative voltage is applied to the cathode electrode layer, the organic layer emits a light having a certain wavelength.

Recently, the organic electroluminescent device has been employed as a display device in a mobile terminal. Here, the mobile terminal indicates portable terminal such as digital phone, cellular phone and personal communication service phone, etc. A user may communicate with other people through the mobile terminal, and exchange various data with other people.

FIG. 1 is a plan view illustrating a display section in a mobile phone.

In FIG. 1, the display section 100 in the mobile phone includes main display area 110 and indicator area 120.

The main display area 110 displays various kinds of information corresponding to a menu selected by a user.

The indicator area 120 displays various kinds of information concerning to the mobile phone, particularly information concerning to present condition of the mobile phone. For example, at least one indicator for showing antenna condition, vibration condition, message receiving condition, residual quantity of a battery, etc. is displayed in the indicator area 120 as shown in FIG. 1.

Unlike the main display area 110 where first image is frequently changed in accordance with menu selected by a user, second image as indicator is not changed in the indicator area 120. Accordingly, sub-pixels corresponding to the second image emit continuously a light. As a result, efficiency of the sub-pixels is deteriorated, and lifetime of the sub-pixels is reduced.

FIG. 2 is a plan view illustrating an after-image shown on a display section.

As shown in FIG. 2, a certain image as indicator is continuously displayed without change, and thus an after-image 130 is shown in the indicator area 120 in case that a certain period of time elapses.

In the mobile terminal, the main display area 110 displays a first image and the indicator area 120 displays a second image in case of a first mode. Then, in case that the first mode is converted into a second mode, the display section 100 may display one image without displaying separately images in the indicator area 120 and the display area 110, respectively. For example, in case of a camera mode, the display section 100 displays wholly one image.

As described above, an image corresponding to the indicator is continuously displayed without change. Accordingly, though first sub-pixels in the indicator area 120 is preset to have the same brightness with second sub-pixels in the display area 110, the first sub-pixels emit a light having smaller brightness than the second sub-pixels. As a result, an after-image corresponding to the image displayed in the indicator area 120 is displayed on the display device 100 as shown in FIG. 2. Hence, a display device where efficiency of specific sub-pixels corresponding to an indicator is not deteriorated has been required. In addition, a display device where an after-image is not displayed has been required.

### SUMMARY OF THE INVENTION

It is a feature of the present invention to provide a display device where an after-image is not displayed on a panel and a method of driving the same.

A display device according to one embodiment of the present invention includes a panel and a driver. The panel displays at least one indicator. The driver drives the panel. Here, the indicator is changed by a predetermined way.

An organic electroluminescent device according to one embodiment of the present invention includes a panel, a data outputting circuit and a data driving circuit. The panel has a plurality of sub pixels formed in cross areas of data lines and scan lines, and display at least one indicator. The data outputting circuit outputs a plurality of display data. The data driving circuit provides data currents corresponding to the display data outputted from the data outputting circuit to the data lines so that the panel displays the indicator. Here, color of the indicator is changed by periods in accordance with the display data.

A method of driving a display device having a panel for displaying at least one indicator according to one embodiment of the present invention includes (a) displaying the indicator on the panel with a first color using first display data; and (b) displaying the indicator on the panel with a second color using second display data. Here, the second color is different from the first color.

As described above, a display device and a method of driving the same of the present invention changes with a predetermined pattern an indicator, and thus an after-image is not occurred on a panel. In addition, the efficiency of pixels corresponding to the indicator is not deteriorated.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plan view illustrating a display section in a mobile phone;

FIG. 2 is a plan view illustrating an after-image shown on a display section;

FIG. 3 is a view illustrating a display device according to one embodiment of the present invention;

FIG. 4 is a timing diagram illustrating scan signals provided to sub-pixels in FIG. 3; and

FIG. 5 is a flowchart illustrating a process of driving the first pixels of the pixels included in the display device of FIG. 3.

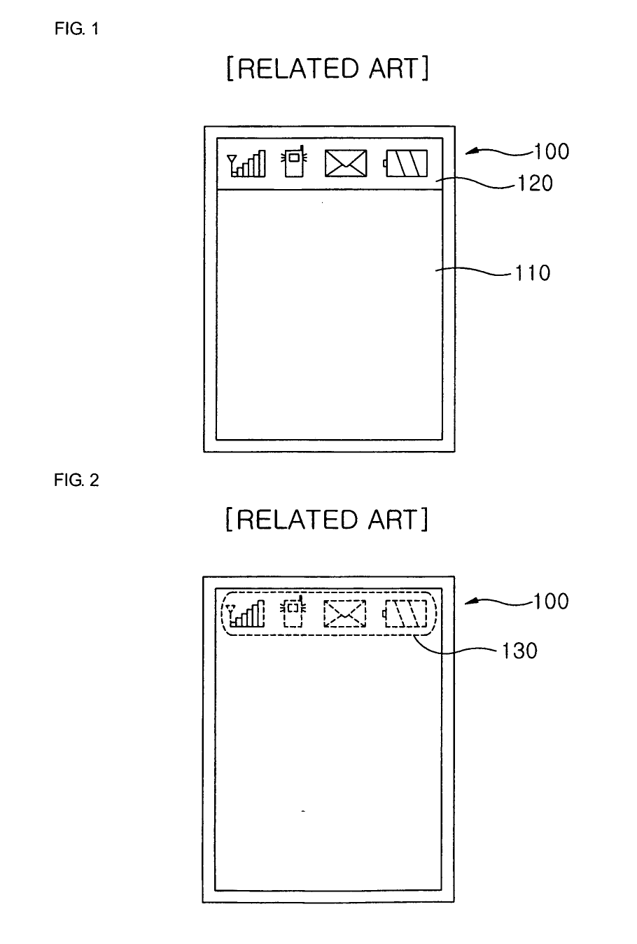

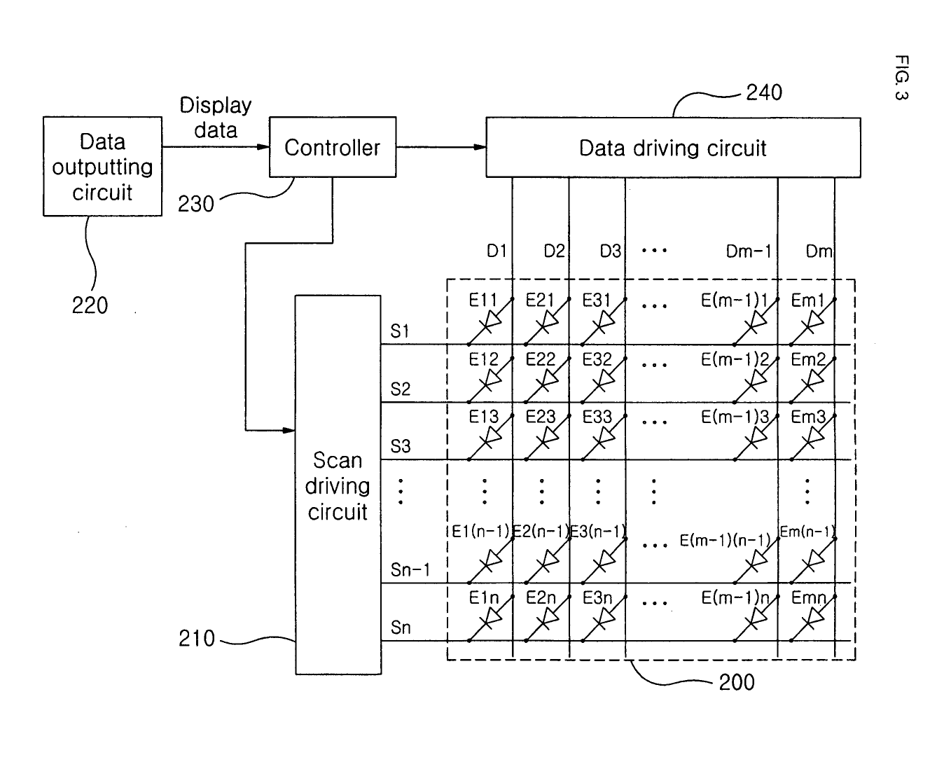

### DESCRIPTION OF EMBODIMENTS

Hereinafter, the preferred embodiments of the present invention will be explained in more detail with reference to the accompanying drawings.

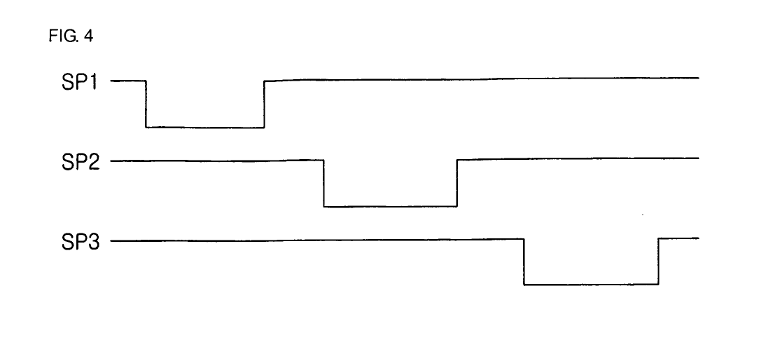

FIG. 3 is a view illustrating a display device according to one embodiment of the present invention. FIG. 4 is a timing diagram illustrating scan signals provided to pixels in FIG. 3.

In FIG. 3, the display device of the present invention includes a panel 200 and a driver. Here, the driver has a scan driving circuit 210, a data outputting circuit 220, a controller 230 and a data driving circuit 240.

The light emitting device according to one embodiment of the present invention includes an organic electroluminescent device, a plasma display panel, a liquid crystal display, and others. Hereinafter, the organic electroluminescent device will be described as an example of the light emitting device for convenience of the description.

The panel 200 includes a plurality of sub-pixels E11 to Emn formed in cross areas of data lines D1 to Dm and the scan lines S1 to Sn.

Each of the sub-pixels E11 to Emn has an anode electrode layer, an organic layer and a cathode electrode layer deposited in sequence on a substrate. When a positive voltage is provided to the anode electrode layer and a negative voltage is provided to the cathode electrode layer, a sub-pixel formed in cross area of the anode electrode layer and the cathode electrode layer emits a light having a certain wavelength.

The sub-pixels E11 to Emn form pixels in unit of N (integer of above 2). For example, one pixel is made up of a first sub-pixel for emitting a red light, a second sub-pixel for emitting a green light, and a third sub-pixel for emitting a blue light. Here, the first to third sub-pixels are located in sequence. For another instance, one pixel may be made up of a first sub-pixel for emitting a red light, a second sub-pixel for emitting a green light, a third sub-pixel for emitting a blue light, and a fourth sub-pixel for emitting white light.

The data outputting circuit 220 provides display data, e.g. RGB data to the controller 230. Particularly, the data outputting circuit 220 provides display data for changing first pixels located in a specific area of the whole pixels with a predetermined pattern to the controller 230.

In one embodiment of the present invention, the specific area indicates an indicator area of a display section in a mobile terminal. Here, the indicator area means area for displaying indicator for providing the condition information of the mobile terminal such as antenna condition, residual quantity of a battery, etc. Here, the indicator may be changed in view of shape or color and others if the indicator shows the condition information of the mobile terminal.

The controller 230 controls the scan driving circuit 210 and the data driving circuit 240 in accordance with the display data provided from the data outputting circuit 220.

The scan driving circuit 210 provides scan signals SP1 to SPn as shown in FIG. 4 to the scan lines S1 to Sn under control of the controller 230. In particular, the scan driving circuit 210 provides the scan signals SP1 to SPn each having a low logic area and a high logic area to the scan lines S1 to Sn. Here, the sub-pixels E11 to Emn emit light at the low logic areas of the scan signals SP1 to SPn.

The data driving circuit 240 provides data currents corresponding to the display data to the data lines D1 to Dm under control of the controller 230. Here, the data currents are synchronized with the scan signals SP1 to SPn.

Hereinafter, a method of driving the first pixels will be described in detail with reference to a process of driving sub-pixels E11 to Em11 corresponding to a first scan line S1.

A first sub-pixel E11 of the pixels E11 to Em11 corresponding to the first scan line S1 emits a red light, a second sub-pixel E21 emits a green light, and a third sub-pixel E31 emits a blue light. Hereinafter, a 1-1 pixel of the first pixels is assumed to be made up of the first to third sub-pixels E11, E21 and E31.

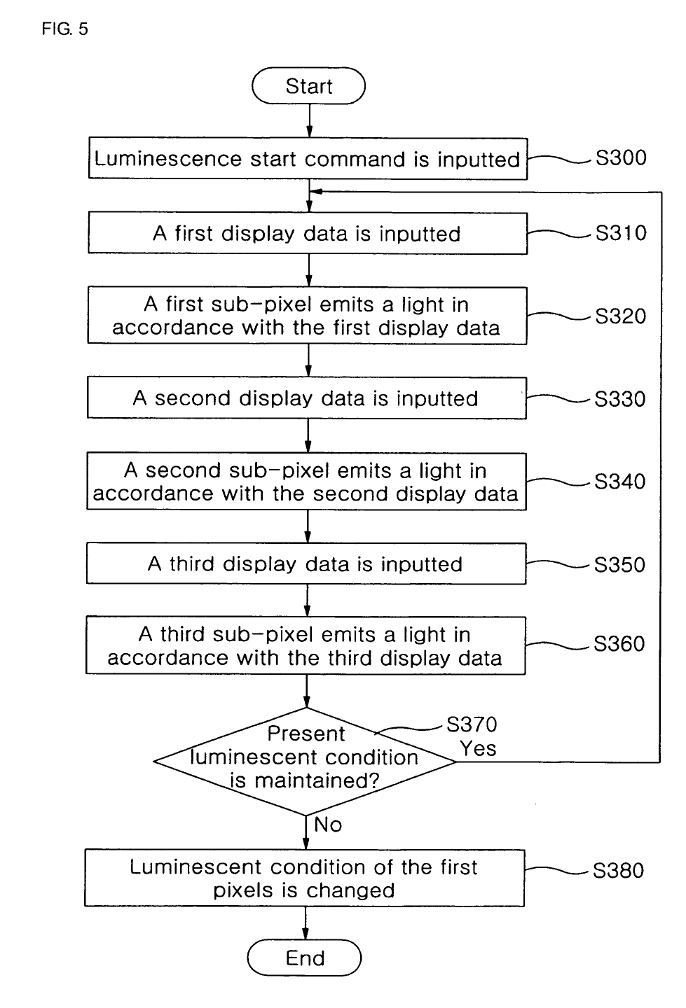

FIG. 5 is a flowchart illustrating a process of driving the first pixels of the pixels included in the display device of FIG. 3.

Firstly, in step S300, a luminescence start command is provided to the data outputting circuit 220.

In step S310, the data outputting circuit 220 inputs a first display data for driving the first pixels to the controller 230 in accordance with the luminescence start command. Here, the first display data drives only the first sub-pixel E11 of the 1-1 pixel.

In step S320, the data driving circuit 240 provides data current corresponding to the first display data to the data lines D1 to Dm under control of the controller 230. Here, the first display data is data for driving only the first sub-pixel E11 of the 1-1 pixel, and thus the data current is provided to only a first data line D1 of the first to third data lines D1 to D3. Accordingly, when the first scan signal SP1 is provided to the scan line S1, the first sub-pixel E11 emits a light, but the second and third sub-pixels E21 and E31 do not emit light. As a result, the 1-1 pixel emits a red light.

In step S330, the data outputting circuit 220 inputs a second display data for driving the first pixels to the controller 230. Here, the second display data is data for driving only the second sub-pixel E21 of the 1-1 pixel.

In step S340, the data driving circuit 240 provides data current corresponding to the second display data to the data lines D1 to Dm under control of the controller 230. Here, the first display data is data for driving only the second sub-pixel E21 of the 1-1 pixel, and thus the data current is provided to only the second data line D2 of the first to third data lines D1 to D3. Accordingly, when the first scan signal SP1 is provided to the first scan line S1, the second sub-pixel E21 emits a light, but the first and third sub-pixels E11 and E31 do not emit light. As a result, the 1-1 pixel emits a green light.

In step S350, the data outputting circuit 220 inputs a third display data for driving the first pixels to the controller 230. Here, the third display data is data for driving only the third sub-pixel E31 of the 1-1 pixel.

In step S360, the data driving circuit 240 provides data current corresponding to the third display data to the data lines D1 to Dm under control of the controller 230. Here, the third display data is data for driving only the third sub-pixel E31 of the 1-1 pixel, and thus the data current is provided to only the third data line D3 of the first to third data lines D1 to D3. Accordingly, when the first scan signal SP1 is provided to the first scan line S1, the third sub-pixel E31 emits a light, but the first and second sub-pixels E11 and E21 do not emit light. As a result, the 1-1 pixel emits a blue light.

In step S370, it is determined whether or not the present luminescent condition of the first pixels is maintained. In other words, it is determined whether or not the indicator is continuously displayed in the indicator area.

In case that the first pixels maintain the present luminescent condition, the step S310 is performed again.

Whereas, in step S380, in case that the first pixels do not maintain the present luminescent condition, the first pixels, the luminescent condition of the first pixels is changed. For example, in case that mode of the mobile terminal is converted from a first mode into a second mode so that one image is displayed on the display section including the indicator area and the main display area, the luminescent condition of the first pixels are changed so that the first pixels emit light corresponding to the image.

In the above description, the first pixels emit a light having one color of red, green and blue. However, in the display device according to another embodiment of the present invention, the first pixels may emit a light having a color made by combining at least two colors of red, green and blue.

On the other hand, in case that the first pixel is made up of four sub-pixels each corresponding to red, green, blue and white, the first pixel emits a light having one color of red, green, blue and white. In addition, in the display device according to another embodiment of the present invention, the first pixel may emit a light having a color made by combining at least two colors of red, green, blue and white.

As described above, the display device of the present invention changes the color of the indicator by using a certain way. It is desirable that the display device changes the color of the indicator by periods.

The display device according to another embodiment of the present invention may change the shape of the indicator with a preset pattern so that an after-image is removed.

From the preferred embodiments for the present invention, it is noted that modifications and variations can be made by a person skilled in the art in light of the above teachings. Therefore, it should be understood that changes may be made for a particular embodiment of the present invention within the scope and the spirit of the present invention outlined by the appended claims.

What is claimed is:

1. A display device comprising:
a panel configured to display at least one indicator; and
a driver configured to drive the panel,
wherein the indicator is changed by a predetermined way.

2. The display device of claim 1, wherein the indicator is changed by periods.

3. The display device of claim 1, wherein the indicator is irregularly changed.

4. The display device of claim 1, wherein at least one of color or shape of the indicator is changed.

5. The display device of claim 1, wherein the indicator has a color made by combining red, green and blue.

6. The display device of claim 1, wherein the indicator has one color when the indicator is displayed on the panel.

7. The display device of claim 6, wherein the one color is one selected from the group comprising of red, green and blue.

8. The display device of claim 1, wherein the panel includes a plurality of sub pixels formed in cross areas of data lines and scan lines.

9. The display device of claim 8, wherein at least one sub pixel includes an anode electrode layer, an organic layer and a cathode electrode layer deposited in sequence on a substrate.

10. The display device of claim 8, wherein the driver includes:
a scan driving circuit configured to provide scan signals to the scan lines; and
a data driving circuit configured to provide data currents synchronized with the scan signals to the data lines.

11. The display device of claim 9, wherein the driver further includes:
a data outputting circuit configured to provide a plurality of display data; and
a controller configured to control the scan driving circuit and the data driving circuit using the display data provided from the data outputting circuit,
wherein the data currents correspond to the display data.

12. The display device of claim 11, wherein the display data includes first display data corresponding to red light, second display data corresponding to green light and third display data corresponding to blue light.

13. The display device of claim 1, wherein the indicator is displayed on only some area of the panel.

14. The display device of claim 1, wherein the display device is electroluminescent device.

15. An organic electroluminescent device comprising:
a panel configured to have a plurality of sub pixels formed in cross areas of data lines and scan lines, and display at least one indicator;
a data outputting circuit configured to output a plurality of display data; and
a data driving circuit configured to provide data currents corresponding to the display data outputted from the data outputting circuit to the data lines so that the panel displays the indicator,
wherein color of the indicator is changed by periods in accordance with the display data.

16. The organic electroluminescent device of claim 15, further comprising:
a controller configured to receive the display data outputted from the data outputting circuit, and control the data driving circuit using the received display data; and
a scan driving circuit configured to provide scan signals to the scan lines under control of the controller.

17. The organic electroluminescent device of claim 15, wherein the indicator has red color, green color or blue color.

18. A method of driving a display device having a panel for displaying at least one indicator, comprising:
(a) displaying the indicator on the panel with a first color using first display data; and
(b) displaying the indicator on the panel with a second color using second display data,
wherein the second color is different from the first color.

19. The method of claim 18, wherein the panel includes a plurality of sub pixels formed in cross areas of data lines and scan lines,
wherein the (a) step includes:
providing data currents corresponding to the first display data to the data lines,
and the (b) step includes:
providing data currents corresponding to the second display data to the data lines.

20. The method of claim 18, further comprising:
(c) displaying the indicator on the panel with a third color using third display data,
wherein the first to third colors are red, green and blue.

21. The method of claim 20, wherein the (a) step, the (b) step and the (c) step are repeated by periods.

22. The method of claim 18, wherein the indicator is displayed on only some area of the panel.
